(19) United States
(12) Patent Application Publication
(10) Pub. No.: US 2015/0014570 A1
(43) Pub. Date: Jan. 15, 2015

(54) PRE INSULATION OF FLOW CONTROL VALVES AND STRAINERS USED IN A PIPING SYSTEM

(71) Applicant: SHRIKANTH SARDA, SECUNDERABAD, TS (IN)

(72) Inventors: Shrikanth Sarda, Secunderabad (IN); Chinnappa Reddy Udumula, Secunderabad (IN)

(21) Appl. No.: 14/379,496

(22) PCT Filed: Feb. 19, 2013
(86) PCT No.: PCT/IB2013/051347

§ 371 Date: Aug. 19, 2014

(30) Foreign Application Priority Data
Feb. 20, 2012 (IN) 632/CHE/2012

(51) Int. Cl. F16L 59/16

(52) U.S. Cl. CPC F16L 59/16
USPC 251/366; 29/455.1

(57) ABSTRACT

Exemplary embodiments and various aspects of the present invention are directed towards a pre-insulated control valve and a strainer of a piping system and a method of pre-insulating a control valve and a strainer. The method involves providing at least one a rigid polymeric foam, casting an insulation layer having a predetermining thickness from the polymeric foam designed to reduce thermal conduction between the valve or the strainer and the surface coming in contact with the valve or the strainer, coupling the control valve or the strainer with the insulation layer to provide a pre-insulated control valve or a pre insulated strainer and engaging the pre-insulated control valve or the pre insulated strainer in the fluid distribution system at multiple predetermined locations.

### TECHNICAL FIELD OF THE INVENTION

The present invention generally relates to insulated flow control valves and strainers. More particularly, the present invention relates to pre-insulated flow control valves and pre insulated strainers and fluid conduction systems and a method of configuring them on industrial scale and to eliminate the requirement of insulation of the valves at working field.

### BACKGROUND OF THE INVENTION

Piping systems otherwise called fluid conduction systems working at above or below normal temperatures and pressure conditions are highly susceptible to corrosion and hazardous to the people working in its vicinity. In typical conduction systems, the rate and quantity of fluid transfer is controlled and operated through valves and their opening and closing function. To enable the piping systems and the operating valves be handled by working people safely, these systems are insulated by different thermal and corrosion resistant materials.

Generally, control valves are insulated in piping systems that conduct high temperature gases, inflammable liquids, compressed natural gases, cryogenic liquids, industrial gas or liquid materials at extreme temperatures and fluidized solids used in various sectors. In industries, the valves are used in oil and gas fields, power generation, mining, water reticulation, sewerage, HVAC, fire and chemical manufacturing. Especially in power plants, utility industries and chemical process industries, valves are used to control fluid conduction in large expanses of pipes carrying the fluids, super-heated steam and other materials at high temperatures. The insulation is essential for the valves to efficiently control steam, heated humid air or mist, hot materials, condensate, lubricants, cryogenic fluids and cold materials used in heating and air conditioning, power facilities, food processing facilities and petrochemical facilities.

To ensure the safety of an individual who comes in contact with the piping system and it's components including tubing, piping, conduiting, fittings and valves, they are insulated with a variety of polymers which resist the thermal conduction and protects the piping system from environmental conditions.

The existing industrial piping applications require insulation about the tubing, piping, conduiting, fittings and valves. The air distribution system needs a valve with an effective insulating capacity to maintain thermal energy of the air flow within a desired range. The Liquefied Natural Gas (LNG) piping system requires a valve with electrical insulating capacity for cutting off the current to be flowed along the pipe line. Usage of conventional insulation materials including asbestos, fiberglass requires substantial installation time and further treatment for preservation of the insulation against weather, moisture and other harsh chemicals.

The insulation in conventional methods can be opened, placed around pipe section and then closed to create a solid blanket of insulation extending around the circumference of the pipe. The insulation is usually covered by a jacket including a pressure sensitive tape closure system for binding the insulation section together. Adjacent sections of the insulation are placed on the pipe in an abutting end-to-end relationship. But, a more complex geometrical configuration of valves and other components in the piping installation make the insulating job more difficult with regard to them.

The insulation for the valves is done after fixing the valves at site using different insulation methods and various insulation materials including asbestos pliable corded wrap (around stem), asbestos mud (damaged crusty shell), grey asbestos paper, and non-asbestos “horse” hair (secured with twine) and the like. But, this onsite insulation of the valves is undesirable due to improper and unplanned work, failure in estimation of quality and quantity of the insulating material needed to be applied for the valves.

The onsite insulation methods include manual power to reach the site, to visually check the valves. One way of insulating the valves would be to spray or encase the valve arrangement with a suitable asbestos or other insulating material. On using an “integral” or encasement type of insulation, the valve insulation should be stripped and replaced every time for repairing the valve. Further, the insulation around pipe valves is often destroyed at time of accessing the valves for valve maintenance, repairs and the like. Once the insulation is removed it is often difficult to replace. So this type of insulation would be expensive for additional insulation and requires additional man hours. These onsite insulation methods are highly tedious, laborious, time-consuming and therefore and not very efficient. Maintenance of the inefficient insulation needs time bound manual inspection. Further the onsite insulation management with its delayed maintenance fails to provide real time maintenance.

The valve insulation covers are wrapped and tied around valves. These covers are a composite of various materials and are typically made up of fiberglass materials encapsulated between protective and moisture retardant covering. The valve covers are reusable as they are removed from a valve if the valve is to be repaired and then replaced on the valve after the repair. Commonly, the valve covers are made of a flexible blanket type material and rest of the insulation in the piping system is customarily a rigid type of insulation. Due this the blankets do not give a uniform look to the insulation. In addition, the installation of the valve covers is very difficult especially to the large valves with complex curves. Hence, the valve insulation increases labor costs required for installing or for reinstalling them in the event of valve repairs.

Hence, application of conventional valve insulating methods is associated with limitations like, lack of controlling the fluid/air flow at extreme temperatures, failure in avoiding corrosion at varied temperatures, thus compromising effective function of the valves in flow control applications.

Therefore, it is appreciated to develop pre-insulated control valves and a method of insulation for flow control valves in any piping system, which can flexibly be employed for exhibiting safe flow control operation to efficiently maintain the flow of fluid, gas, steam, air materials with an effective insulation.

### BRIEF SUMMARY OF THE INVENTION

The following presents a simplified summary of the disclosure in order to provide a basic understanding to the reader. This summary is not an extensive overview of the disclosure and it does not identify key/critical components of the invention or delineate the scope of the invention. Its sole purpose is to present some concepts disclosed herein in a simplified form as a prelude to the more detailed description that is presented later.

A more complete appreciation of the present invention and the scope thereof can be obtained from the accompanying drawings which are briefly summarized below and the following detailed description of the presently preferred embodiments.

It's an important aspect of the present invention to provide an industrially pre-insulated flow control valves which can be fitted into fluid distribution systems functioning under extreme temperatures and environmental pressures or which perform distribution of gases or fluids which can harm the piping system and the person coming in contact with the system.

According to a first aspect of the present invention, a method of pre-insulating a control valve in a fluid distribution system is disclosed. The method involves providing any rigid polymeric foam to be applied on to the control valve, casting an insulation layer of a predetermining thickness from the rigid polymeric foam that is configured to reduce thermal conduction between the valve and the surface coming in contact with the valve, removably or permanently coupling the control valve with the insulation layer at a predetermined temperature within the fabrication unit to design a pre-insulated control valve and engaging the pre-insulated control valve into the piping system at a plurality of predetermined locations.

According to the first aspect of the present invention, the rigid polymeric foam consists utilizing polyurethane foam with predetermined closed cell content.

According to the first aspect of the present invention, the rigid polymeric foam consists utilizing polyisocyanurate foam with predetermined closed cell content.

According to the first aspect of the present invention, the step of casting the insulation layer comprises sealing the valve, an element of the piping system and both with polyurethane foam involving a predetermined thickness.

According to the first aspect of the present invention, the insulation layer is fabricated to releasably join with the valve, the fluid distribution system and the both by a means of one or more than one fastening provision.

According to the first aspect of the present invention, engaging the pre-insulated control valve into the fluid distribution system involves providing a plurality of radially operable, releasable joints on the longitudinally extended insulation layer, wherein the joints are configured to releasably attach the pre-insulated valve with the components of the fluid distribution system.

According to a second aspect of the present invention, a method of pre-insulating a strainer in a piping system is disclosed. The method involves providing any rigid polymeric foam to be applied on to the strainer, casting an insulation layer of a predetermining thickness from the rigid polymeric foam that is configured to reduce thermal conduction between the strainer and the surface coming in contact with the strainer, removably or permanently coupling the strainer with the insulation layer at a predetermined temperature within the fabrication unit to design a pre-insulated strainer and engaging the pre-insulated strainer into the piping system at a plurality of predetermined locations.

According to a third aspect of the present invention, a pre-insulated control valve of a piping system is described. The pre insulated valve includes a control valve fabricated and essentially sealed with at least one a rigid polymeric foam comprising a predetermined thickness that configures the pre-insulated control valve. The pre-insulated control valve is fitted at right angle in a cylindrically elongated, multi component piping system. A plurality of joining provisions on the radial walls of the insulation layer is enabled to create a multi-fragment insulation layer.

According to the third aspect of the present invention, the pre-insulated valve essentially resists the transfer of heat from and into the piping system to enable safe handling of the valve system.

According to the third aspect of the present invention, the pre-insulated valve protects the performance of the fluid distribution in the piping system from extreme environmental conditions.

According to the third aspect of the present invention, the rigid polymeric foam includes at least one of polyurethane, polyisocyanurate and can also be selected from polyethylene, polypropylene, polystyrene, foamed polystyrene, unfoamed polystyrene, polyimide, polytetrafluoroethylene, polytrifluorochloroethylene, acrylate and methacrylate polymers and copolymers, polyadipamide, polyester, polyvinyl chloride polymers and copolymers.

### BRIEF DESCRIPTION OF THE DRAWINGS

The above-mentioned and other features and advantages of this present disclosure, and the manner of attaining them, will become more apparent and the present disclosure will be better understood by reference to the following description of embodiments of the present disclosure taken in conjunction with the accompanying drawings, wherein:

FIG. 1 is a diagram depicting a cross section of the pre-insulated control valve installed in a fluid distribution system.

FIG. 2 is a diagram depicting an over view of the pre-insulated control valve installed in a fluid distribution system.

FIG. 3 is a diagram depicting an over view of a pre insulated butterfly valve.

FIG. 4 is a flow chart depicting a process for insulating a flow control valve.

FIG. 5 is a diagram depicting utilization and application of a pre insulated flow control valve.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another. For a better understanding, components of the described embodiment are labeled with three digit component numbers. In general, the same first digit is used throughout the entire component numbers numbered and labeled within a figure. Like components are designated by like reference numerals throughout the various figures.

Exemplary embodiments of the present invention are directed towards a method of pre-insulating a control valve in a fluid distribution system, wherein the method includes the steps: providing a rigid polymeric foam to be applied on to the control valve; casting an insulation layer of a predetermining thickness from the rigid polymeric foam configured to reduce thermal conduction between the valve and the surface coming in contact with the valve; removably coupling the control valve with the insulation layer at a predetermined temperature within the fabrication unit to design a pre-insulated control valve; and engaging the pre-insulated control valve into the fluid distribution system at predetermined locations.

According to an exemplary aspect of the present invention, the choice of insulating material depends on the thermal insulation coefficient offered by the material. Conventionally, many polymers and non-polymer materials are used for this purpose.

According to an exemplary aspect of the present invention, most preferably used polymers are in an order of: polyurethane, polyisocyanurate, polyethylene, polypropylene, polystyrene, foamed polystyrene, unfoamed polystyrene, polyimide, polytetrafluoroethylene, polytrifluorochloroethylene, acrylate and methacrylate polymers and copolymers, polyadipamide, polyester, polyvinyl chloride polymers and copolymers.

In a preferred embodiment of the present invention, polyurethane foam (PUF) is used as the insulating material on the control valves and the components of the piping system. PUF is synthesized in the fabrication unit following conventional methods. The method employed particularly involves reacting a poly hydric alcohol (polyol) with isocyanate in the presence of a suitable catalyst forming PUF, wherein the polyurethane cells are blown by blowing agents such that forming light weight PUF having closed cell content of 85% or above, whereas the density of PUF is within a range of 4 to 4.5 pounds per cubic foot with in a range of 295.56 Kg/m³ to 332.505 Kg/m³.

In an alternate embodiment of the present invention, polyisocyanurate foam is employed as the insulating material. This polymer is synthesized by reacting one or more that one active hydrogen containing polyols with a suitable polyisocyanates in the presence of predefined blowing agents to achieve a predefined closed cell content. In an exemplary embodiment, the polyisocyanurate has closed cell content of 85% or above and a density within a range of 4 to 4.5 pounds per cubic foot or with in a range of 295.56 Kg/m³ to 332.505 Kg/m³.

In accordance with a non limiting exemplary aspect, the method of pre-insulating the control valves begins with a step of selecting a rigid polymeric foam as depicted in the preceding paragraphs. The chosen material is polyurethane foam having a closed cell content of 85%. The PUF is fabricated at specific temperatures to form a sealing cover on the control valve and the components of the piping system. In an alternate embodiment, the polymer material can be coated onto the valves and other components of the piping system through thermal spraying. The method of thermal spraying involves a step of projecting the coating material from a spray gun on to the surface to be coated with chosen material. This step is performed in a manner that is known to the person skilled in the art.

The step of casting an insulation layer of a predetermining thickness from the rigid polymeric foam is accomplished through moulding the polymer foam in a predetermined shapes and dimensions having a specified thickness at the fabrication unit. This step results in an easily detachable insulation layer that can be wrapped around selected component of the piping system and be affixed using fastening provisions present at the dorsal and ventral surface of the cylindrically extended insulation layer.

In one exemplary embodiment, the fastening provisions present on the dorsal surface are a latch and socket fabricated on the contacting ends of two adjacent fragments of the insulation layer. The fastening provisions can also be slidable insulation fragments having corresponding threading on their contacting ends. The fastening provisions are fabricated in the insulation layer and their various designs and utility are common and know to those skilled in the art.

Exemplary embodiments of the present invention also provide for insulation of other types of pipe fitting including but not limited to 90.degree. elbows, 45.degree. elbows, tees, wyes, unions, reducers, caps, clean outs. The method of pre-insulation shall not only be restricted to valve but can also be adopted to any other pipe line components like traps, strainers, pressure reducers, actuators, flanges, flow restrictors, metering devices.

In an exemplary aspect of the present invention, the insulation layer is configured to significantly reduce thermal conduction between the valve and the surface coming in contact with the valve, and typically the resistance offered by the insulation layer is expressed in ‘R-value’ which denotes thermal insulation. It is therefore an objective of the invention to substantially increase the thermal insulation as well resistance to a variety of adverse conditions including but not limited to corrosion resistance, moisture resistance, flame resistance, heat resistance and chemical resistance.

In accordance with a non limiting exemplary aspect, the polyurethane and polyisocyanurate insulated control valves and the insulated components of the piping systems are widely employed in a variety of applications like power generation systems, water supplying systems, chemical manufacturing systems, air conditioning systems, gas supplying systems, fire fighting system and industrial systems.

In accordance with a non limiting exemplary aspect, coupling the control valve with the insulation material forms a pre-insulated valve. This step involves enclosing a chosen component of the piping system with a fragment of the insulation layer in manner such that ventral portion of the piping components like the valve are covered first. The two hollow, semi cylindrical sleeves of the insulation layer are joined by a hinge portion on the ventral side of the insulated piping and the two insulation sleeves are coupled together firmly through latch and socket placed at regular distances on the ventral side of the insulation layer.

According to an exemplary aspect of the present invention, the two hollow, semi cylindrical sleeves of the insulation layer are brought closer at the top surface also to entirely cover the valve and/or any component of the piping system and the two sleeves are firmly joined through latch and socket provisions located on the dorsal side of the insulation layer. Thus, the valve or components of the piping are completely and tightly enclosed by the insulation layer. The joining portions of the insulation layer can further be sealed with any impermeable covering layer to avoid the entry of moisture into the space between the piping components and the inner walls of the insulation layer.

In accordance with a non limiting exemplary aspect of the present invention, the insulating material is determined based on a specific flow control operation of the flow control valve in varied environmental conditions. The varied environmental conditions include heat conditions, cold conditions, steam conditions, cryogenic conditions and the like. The application of the insulating material to the flow control valve at the predefined time and the predetermined temperature enables a perfect bonding of the insulating material and the flow control valve and the strainer. In accordance with a non limiting exemplary aspect of the present invention the different kinds of valves include but not limited to Butterfly valve, Dual Plate Check valve, Balancing valve, Gate valve, Non return valve, Y strainers, POT strainers and ball valve with/without strainer.

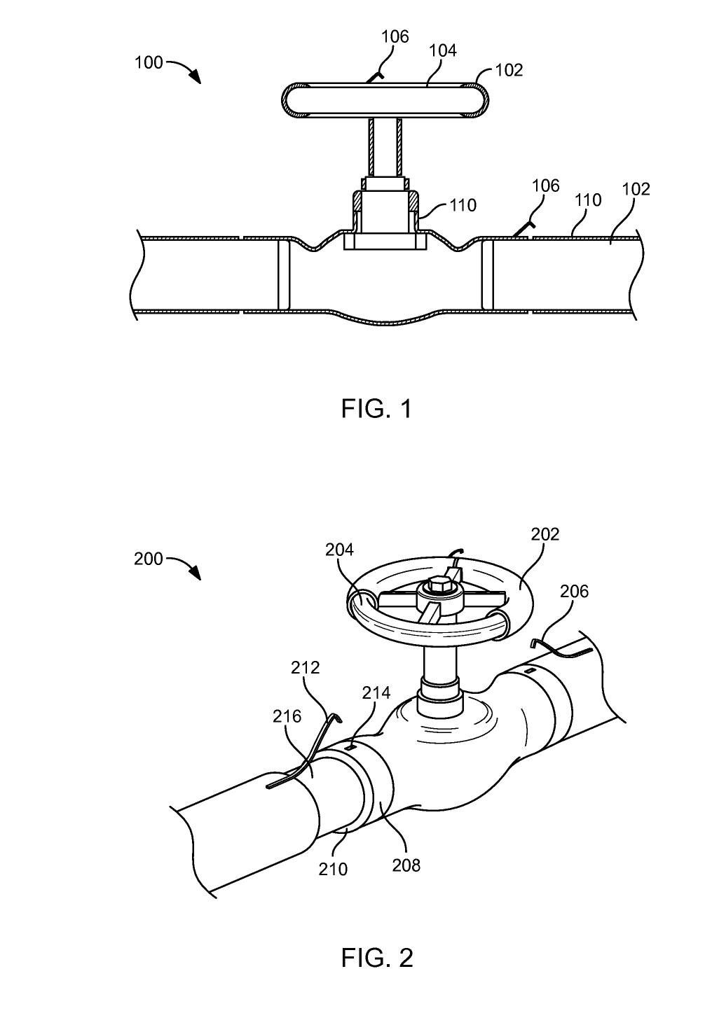

Referring to FIG. 1 is a diagram 100, depicting a cross section of the pre-insulated control valve installed in a fluid distribution system. According an exemplary embodiment, the pre-insulated valve 104 is enveloped with the polyurethane foam material 102 that acts as an insulation layer to protect the fluid distribution from external environmental adversaries, as well to provide a safe handling of the valve and piping components by people coming into contact with them. The piping components like the tubing and valve junctions are also insulated at the fabrication unit with two hollow, semi cylindrical polymer sleeves 110 which are coupled on ventral and dorsal surfaces of the insulation layer through uniformly distributed latch and socket provisions 106. These fastening provisions 106 are located on the dorsal and ventral surfaces of the insulation layer to facilitate a close and firm wrapping of the polymer layer around the valves and other components of the piping system.

In accordance with an exemplary aspect of the present invention, sealing the valves and the components of the piping system with polyurethane or polyisocyanurate involves pre-fabricating flexible, semi cylindrical polymer sleeves 110 designed to cover different components of the piping system and valves. These polymer sleeves are wrapped onto the valve or any piping component to completely cover them. Once the assembling process is completed, the sleeves are securely fixed through the fastening provisions 106 located on top and bottom surfaces at the contacting ends of polymer sleeve portions. The insulated valves and the piping enveloped by polymer sleeves are optionally protected by sealing the contacting ends of the insulation layer fragments with thin, impermeable polyethylene sheet or a similar sealant.

Referring to FIG. 2 is a diagram 200, depicting an over view of the pre-insulated control valve installed in a fluid distribution system. The flow control valve 204 is fabricated and insulated at the manufacturing unit in a custom made choice. The insulation layer 202 is configured according to the application. The thickness of the polymer layer is predetermined in a manner that is known to the skilled person and the insulation layer is fabricated. The flexible insulation layer is made in one or more than one sleeve which can be wrapped around the valve and other parts of the piping 216.

According to an exemplary aspect of the present invention, the insulation material is multi-fragmented or completely sealed by heating for enabling a hassle-free sealing of the differently shaped valves and various components of the piping. The contacting ends of each insulation fragment with its adjacent fragments may be secured through said fastening mechanism. This provides for detaching the insulation for any service of the piping components or valves without disturbing the function of fluid distribution and without deforming the structure and assemblage of the piping system. The insulating material includes rubber, thermocol, fiberglass, polyetheretheketone, a polyurethane, a polyisocyanurate, a polyethylene; a polypropylene, polystyrene, a foamed polystyrene, a unfoamed polystyrene, a polyimide, a polytetrafluoroethylene, a polytrifluorochloroethylene, a polystyrene foam, a cellular glass, a calcium silicate and a nitrile foam rubber.

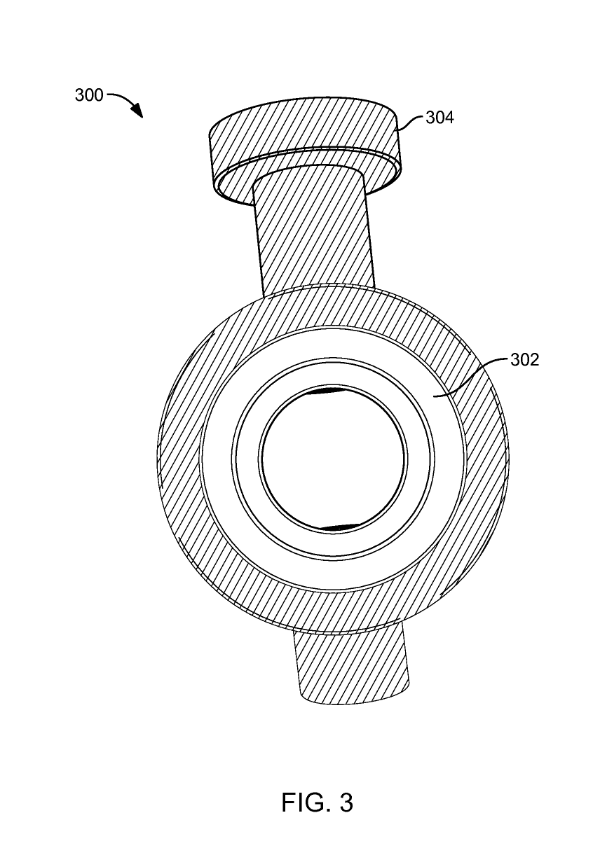

Referring to FIG. 3 is a diagram 300 depicting an over view of a pre insulated butterfly valve. The butterfly valve 302 is pre insulated at industry level with an appropriate insulation material 304. The butterfly valve 302 is pre insulated with the insulation material 304 at a predetermined thickness. The insulating material 304 may include but not limited to a polyurethane; a polyisocyanurate, a polyethylene, a polypropylene, polystyrene, a foamed polystyrene, a unfoamed polystyrene, a polyimide, a polytetrafluoroethylene, a polytrifluorochloroethylene, a polystyrene foam, a fiberglass, a cellular glass, a calcium silicate, and a nitrile foam rubber.

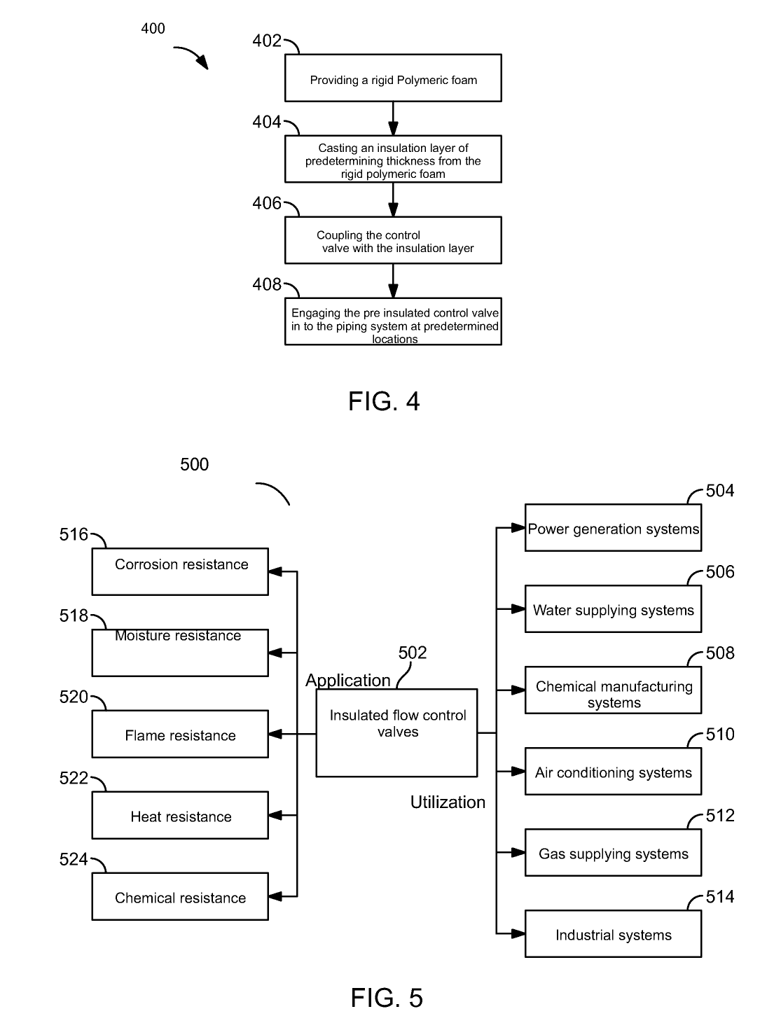

Referring to FIG. 4 is a diagram 400 depicting the flow chart depicting a process for insulating a flow control valve. The diagram briefly describes the claimed process of pre-insulation. This process begins with the step of 404 which explains providing suitable polymer foam like polyurethane for insulation. This step is followed by 406 which describe the step of casting an insulation layer of a predetermining thickness from polyurethane or polyisocyanurate which is essentially configured to reduce thermal conduction between the valve and the surface coming in contact with the valve.

According to an exemplary aspect of the invention, the step of casting insulation layer proceeds with step 408 that describes the manner in which a pre-insulated control valve is provided by removably or permanently coupling the control valve with a polyurethane insulation layer having a predetermined thickness. The manner in which this step is achieved is described in the detailed description and can be understood by a person skilled in the art.

The process ends in step 410 that describes engaging the pre-insulated control valve into the fluid distribution system at predetermined locations. This step results in efficiently insulated fluid distribution system in which a control valve or any component can be safely handled and operated despite the hazardous thermal or pressure potential of the gases or fluids distributed in side the system. The step of engaging pre-insulated control valves can be accomplished by any conventional technique.

Referring to FIG. 5 is a diagram 500 depicting utilization and application of a pre insulated flow control valve. This is a schematic diagram to describe a complete picture of the inventions' functional application and its' utilization in various sectors. The element 502 is an insulated flow control valve performing various functionalities like corrosion resistance 516, moisture resistance 518, flame resistance 520, heat resistance 522 and chemical resistance 524.

As will be appreciated by a person skilled in the art, the insulated flow control valve 502 is widely employed in a various sectors where the distribution of gases or liquids at extremely high or low temperatures and/or having high pressure is commonly seen. The utilization of pre-insulated flow control valves or piping components is not limited to the following: power generation systems 504, water supplying systems 506, chemical manufacturing systems 508, air conditioning systems 510, gas supplying systems 512 and industrial systems 514.

As will be appreciated by a person skilled in the art the present invention provides a variety of advantages. Firstly, the present invention provides insulation for the flow control valve based on a specific flow control operation and eliminates the insulation of the valves at working field. Secondly, the present invention provides insulated flow control valves with a corrosion resistance, a moisture resistance, a flame resistance, a heat resistance, a chemical resistance against varied environmental conditions. Thirdly, the present invention provides insulation for the flow control valve which enables an effective durability of the flow control valve against the varied environmental conditions. Fourthly, the present invention provides insulated flow control valves which can be utilized in power generation system, water supplying system, chemical manufacturing system, air conditioning system, gas supplying system, industrial system.

While specific embodiments of the invention have been shown and described in detail to illustrate the inventive principles, it will be understood that the invention may be embodied otherwise without departing from such principles.

1. A method of pre-insulating a control valve in a piping system, comprising:
providing at least one rigid polymeric foam;
casting an insulation layer of a predetermined thickness from the rigid polymeric foam configured to reduce thermal conduction between the valve and a surface coming in contact with the control valve;
coupling the control valve with the insulation layer to provide a pre-insulated control valve; and
engaging the pre-insulated control valve at a plurality of predetermined locations in the piping system.

2. The method of claim 1, wherein providing the at least one rigid polymeric foam comprises utilizing polyurethane foam with a predetermined closed cell content.

3. The method of claim 1, wherein providing the at least one rigid polymeric foam comprises utilizing polyisocyanurate foam with a predetermined closed cell content.

4. The method of claim 1, wherein casting the insulation layer comprises sealing the valve with the at least one rigid polymeric foam.

5. The method of claim 4, wherein casting the insulation layer comprises sealing the valve and the at least one element of the piping system with a polyurethane foam comprising a predetermined thickness.

6. The method of claim 1, wherein casting the insulation layer comprises sealing at least one element of the piping system with the at least one rigid polymeric foam.

7. The method of claim 6, wherein casting the insulation layer comprises sealing the valve and the at least one element of the piping system with a polyurethane foam comprising a predetermined thickness.

8. The method of claim 1, wherein the insulation layer fabricated with the valve and the at least one element of the piping system optionally secured through a longitudinally extended polymer sheet.

9. The method of claim 1, wherein engaging the pre-insulated control valve into the piping system comprises providing a plurality of radially operable and releasable joints on the insulation layer.

10. The method of claim 9, wherein the plurality of radially operable and releasable joints configured to releasably attach the pre-insulated valve with the components of the piping system.

11. The method of claim 9, wherein the plurality of radially operable and releasable joints configured to permanently attach the pre insulated valve with the components of the piping system.

12. The method of claim 1 further comprising a step of pre-insulating a strainer in a piping system.

13. The method of claim 12 comprising providing at least one rigid polymeric foam; and casting an insulation layer of a predetermined thickness from the rigid polymeric foam configured to reduce thermal conduction between the strainer and a surface coming in contact with the strainer; coupling the strainer with the insulation layer to provide a pre-insulated strainer; and engaging the pre-insulated strainer at a plurality of predetermined locations in the piping system.

14. A pre-insulated control valve of a piping system, the control valve comprising:
a control valve fabricated and sealed with at least one a rigid polymeric foam comprising a predetermined thickness and secured at a predetermined angle in the piping system; and
a plurality of joining provisions on a radial wall of the insulation layer enabled to create a multi-fragment insulation layer.

15. The pre-insulated control valve of claim 14, wherein the pre-insulated valve resists a transfer of heat from and into the piping system to enable safe handling of the valve system.

16. The pre-insulated control valve of claim 14, wherein the pre-insulated valve protects a performance of the fluid distribution in the piping system from extreme environmental conditions.

17. The pre-insulated control valve of claim 14, wherein the rigid polymeric foam comprises at least one of: a polyurethane; a polyisocyanurate; a polyethylene; a polypropylene; polystyrene; a foamed polystyrene; a unfoamed polystyrene; a polyimide; a polytetrafluoroethylene; a polytrifluorochloroethylene; a polystyrene foam; a fiberglass; a cellular glass; a calcium silicate; and a nitrile foam rubber. Nevertheless, insulation material is not only restricted to only polymeric foam but also includes all other materials which may be used for insulation for the desired variety of applications.

18. A pre-insulated strainer of a piping system, the strainer comprising:
a strainer fabricated and sealed with at least one a rigid polymeric foam comprising a predetermined thickness and secured at a predetermined angle in the piping system; and
a plurality of joining provisions on a radial wall of the insulation layer enabled to create a multi-fragment insulation layer.
